(19) United States
(12) Patent Application Publication
(10) Pub. No.: US 2009/0055653 A1
(43) Pub. Date: Feb. 26, 2009

(54) Computerized data management method and computerized data management system using the same

(75) Inventors: Yun-Liang Huang, Taipei (TW); Hsuan-Chih Peng, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/068,886

(22) Filed: Feb. 13, 2008

(30) Foreign Application Priority Data
Aug. 24, 2007 (TW) 96131581

(51) Int. Cl. H04L 9/00

(52) U.S. Cl. 713/182

(57) ABSTRACT

A computerized data management method and a computerized data management system using the same are provided. The computerized data management method is used for encrypting/decrypting a digital data of an electronic device. The computerized data management method comprises the following steps. Firstly, a user's facial characteristic is captured. Next, whether the user's facial characteristic matches with an encrypting-permission user's facial characteristic stored in a database is determined in an encrypting process. If the user's facial characteristic matches with the encrypting-permission user's facial characteristic stored in the database, then the user is allowed to encrypt a digital data. Then, whether the user's facial characteristic matches with a facial characteristic of a decrypting-permission user corresponding a digital data is determined in a decrypting process. If the user's facial characteristic matches with the facial characteristic of the decrypting-permission user corresponding the digital data, then the user is allowed to decrypt the digital data.

This application claims the benefit of Taiwan application Serial No. 96131581, filed Aug. 24, 2007, the subject matter of which is incorporated herein by reference.

### BACKGROUND OF THE INVENTION

1. Field of the Invention

The invention relates in general to a computerized data management method and a computerized data management system using the same, and more particularly to a computerized data management method employing image recognition technology and a computerized data management system using the same.

2. Description of the Related Art

In the age of digitalization and webalization, the protection of digital data is absolutely an urgent need and concern to modern people. The simplest data protection is achieved by way of inputted text incorporated with the encrypting/decrypting operation of cryptography. Currently, there are a number of encrypting operation technologies available such as Public/Private Key, DES, Triple DES, AES, Hash Function, and so on.

In a conventional data protection method, the security of the encrypting operation depends on whether the design of the algorithm is safe and hard to be decrypted, meanwhile the user has to input a complicated password. As a result, the user himself may even forget the password and can not open an encrypted digital data. Besides, verification by pure text is not safe because the password can be stolen or decrypted. Therefore, how to develop a data protection method which provides convenience of use has become an imminent issue to be resolved.

### SUMMARY OF THE INVENTION

The invention is directed to a computerized data management method and a computerized data management system using the same. Whether the user has the permission for encrypting/decrypting a digital data is verified according to the face recognition technology and the encrypting operation. Thus, a new security verification mechanism is achieved and the setting and management of password are made more convenient.

According to a first aspect of the present invention, a computerized data management method is provided. The computerized data management method comprises the following steps.

Firstly, a user's facial characteristic is captured. Next, whether the user's facial characteristic matches with an encrypting-permission user's facial characteristic stored in a database is determined in an encrypting process. If the user's facial characteristic matches with the encrypting-permission user's facial characteristic stored in the database, then the user is allowed to encrypt a digital data. Then, whether the user's facial characteristic matches with a facial characteristic of a decrypting-permission user corresponding a digital data is determined in a decrypting process. If the user's facial characteristic matches with the facial characteristic of the decrypting-permission user corresponding the digital data, then the user is allowed to decrypt the digital data.

According to a second aspect of the present invention, a computerized data management system comprising an image capturing unit, a database, an encrypting unit, a decrypting unit and a processing unit is provided. The image capturing unit is used for capturing a user's facial characteristic. The database is used for storing at least an encrypting-permission user's facial characteristic and at least a decrypting-permission user's facial characteristic. The encrypting unit is used for encrypting a digital data. The decrypting unit is used for decrypting the digital data. In an encrypting process, the processing unit is used for determining whether the user's facial characteristic captured by the image capturing unit matches with the encrypting-permission user's facial characteristic stored in the database. If the user's facial characteristic matches with the encrypting-permission user's facial characteristic stored in the database, then the processing unit the user is allowed to encrypt the digital data. In a decrypting process, the processing unit is used for determining whether the user's facial characteristic captured by the image capturing unit matches with the facial characteristic of the decrypting-permission user corresponding the digital data. If the user's facial characteristic matches with the facial characteristic of the decrypting-permission user corresponding the digital data, then the user is allowed to decrypt the digital data.

The invention will become apparent from the following detailed description of the preferred but non-limiting embodiments. The following description is made with reference to the accompanying drawings.

### BRIEF DESCRIPTION OF THE DRAWINGS

FIG. 1 is a function block diagram of a computerized data management system according to a preferred embodiment of the invention;

FIG. 2 is a flowchart of a computerized data management method according to a preferred embodiment of the invention;

FIG. 3 is a detailed flowchart of the step 240 of FIG. 2;

FIG. 4 is a detailed flowchart of the step 280 of FIG. 2;

FIG. 5 is a detailed flowchart of the step 270 of FIG. 2;

FIG. 6 is a perspective of a display screen according to a preferred embodiment of the invention;

FIG. 7 is a selection menu of the right-key of a mouse according to a preferred embodiment of the invention.

### DETAILED DESCRIPTION OF THE INVENTION

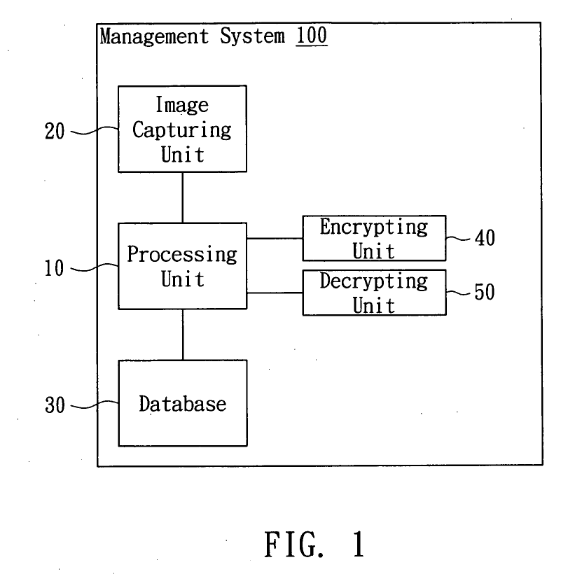

Referring to FIG. 1, a function block diagram of a computerized data management system according to a preferred embodiment of the invention is shown. The computerized data management system 100 comprises an image capturing unit 20, a database 30, an encrypting unit 40, a decrypting unit 50 and a processing unit 10. In the present embodiment of the invention, the image capturing unit 20 is used for capturing a user's facial characteristic. The database 30 is used for storing at least an encrypting-permission user's facial characteristic and at least a decrypting-permission user's facial characteristic. The encrypting unit 40 is used for encrypting a digital data. The decrypting unit 50 is used for decrypting a digital data. In an encrypting process, the processing unit 10 is used for determining whether the user's facial characteristic captured by the image capturing unit 20 matches with the encrypting-permission user's facial characteristic stored in the database 30. If the user's facial characteristic matches the encrypting-permission user's facial characteristic stored in the database 30, then the processing unit 10 allows the user to encrypt the digital data by the encrypting unit 40. In a decrypting process, the processing unit 10 is used for determining whether the user's facial characteristic captured by the image capturing unit 20 matches with the facial characteristic of the decrypting-permission user corresponding the digital data. If the user's facial characteristic matches with the facial characteristic of the decrypting-permission user corresponding the digital data, then the processing unit 10 allows the user to decrypt the digital data by the decrypting unit 50. The decrypting-permission user corresponding the digital data is the user encrypting the digital data. Besides, the user's facial characteristic is generated by an image recognition system (not illustrated). For example, firstly, the user's facial image is tracked according to face tracking technology. Next, the user's facial image is captured according to facial retrieving technology. Then, the facial image is analyzed according to face recognition technology. Lastly, the user's facial characteristic is generated. The user's facial characteristic comprises several kinds of parameters such as the facial contour, skin colors, relative position between the and the sharp of the five sense organs.

Examples of the digital data include a file, a plurality of files, a file folder and a plurality of file folders. Moreover, the digital data can be encrypted and compressed as a compression file by the encrypting unit 40 so that other users are incapacitated of viewing the contents of the compression file such as the number and the names of the files.

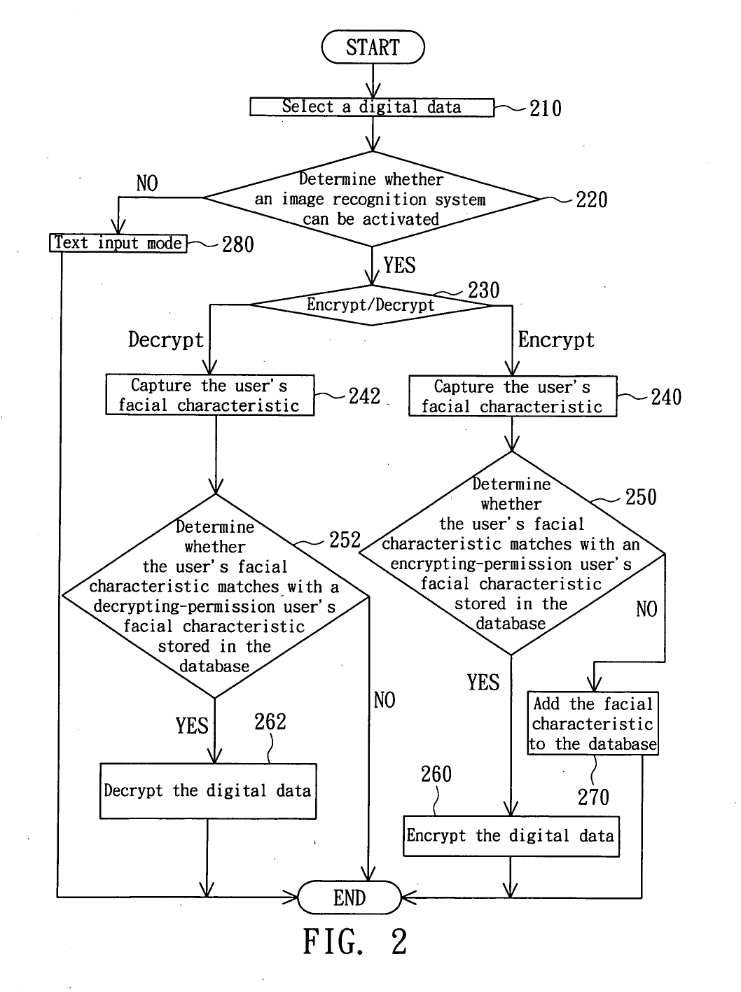

Referring to FIG. 2, a flowchart of a computerized data management method according to a preferred embodiment of the invention is shown. Firstly, the method begins at step 210 of FIG. 2, the user selects a digital data such as a file, a plurality of files, a file folder or a plurality of file folders from a browser interface. The browser interface comprises an encrypting selection and a decrypting selection for the user to choose whether to perform an encrypting process or a decrypting process. The browser interface can be operated under a file explorer of an operating system.

Referring to FIG. 7, a selection menu of the right-key of a mouse according to a preferred embodiment of the invention is shown. The encrypting selection and the decrypting selection can be connected on a mouse right-key selection menu 710 so that the user can click the right-key of a mouse to choose whether to perform an encrypting process or a decrypting process.

Then, the method proceeds to step 220 of FIG. 2, the processing unit 10 determines whether the electronic device can activate an image recognition system. If the electronic device can activate the image recognition system, then an image capturing unit 20 is activated and the method proceeds to step 230. The image capturing unit 20 can be a photographer or a camera. Besides, the image capturing unit 20 can be externally connected to the electronic device or built-in the electronic device.

Next, the method proceeds to step 230 of FIG. 2, the processing unit 10 determines whether the encrypting selection or the decrypting selection is clicked. If the encrypting selection is clicked, then the method proceeds to step 240. If the decrypting selection is clicked, then the method proceeds to step 242.

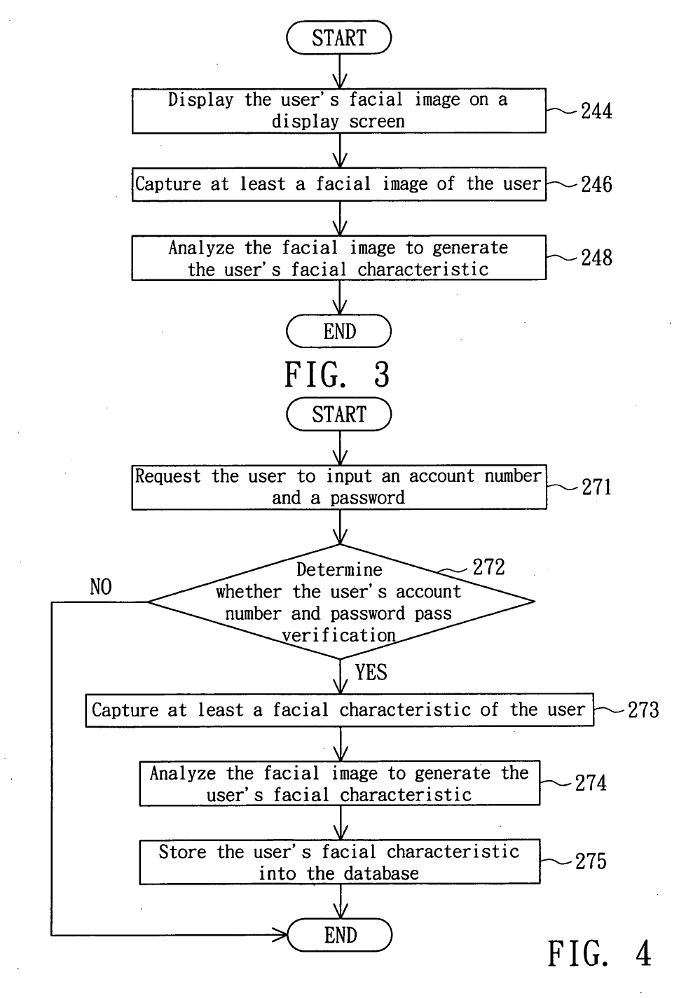

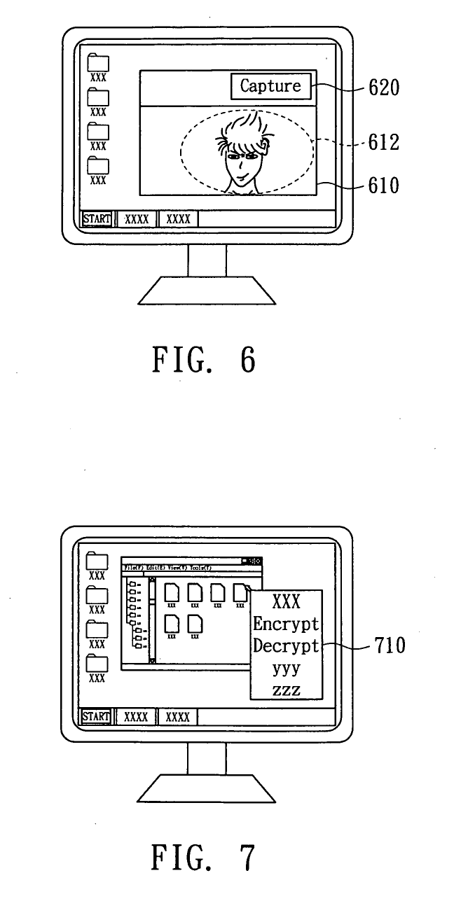

In step 240 of FIG. 2, the user's facial characteristic is captured. Step 240 further comprises several sub-steps. Referring to FIG. 3, a detailed flowchart of the step 240 of FIG. 2 is shown. Firstly, as indicated in step 244, the user's facial image is displayed on a display screen. Referring to FIG. 6 a perspective of a display screen according to a preferred embodiment of the invention is shown. A facial image 612 is displayed on a preview window 610. Then, as indicated in step 246, at least a facial image of the user is captured. The user can click the capturing function key 620 in the preview window 610 of FIG. 6 to capture the user's facial image. Next, as indicated in step 248, the facial image is analyzed according to the image recognition system to generate the user's facial characteristic.

Then, the method proceeds to step 250 of FIG. 2, the processing unit 10 determines whether the user's facial characteristic matches with an encrypting-permission user's facial characteristic stored in the database 30. If the user's facial characteristic matches with the encrypting-permission user's facial characteristic stored in the database 30, then the method proceeds to step 260. If the user's facial characteristic does not match with the encrypting-permission user's facial characteristic stored in the database 30 (that is, the user's facial characteristic is not in the database 30), then the method proceeds to step 270.

After the method proceeds to step 260, the user can encrypt the digital data.

After the method proceeds to step 270, the user can add the user's facial characteristic to the database 30 or once again captures the user's facial characteristic until the processing unit 10 determines that the user's facial characteristic matches with the encrypting-permission user's facial characteristic stored in the database 30.

The step 270 of FIG. 2 comprises a plurality of sub-steps. Referring to FIG. 4, a detailed flowchart of the step 270 of FIG. 2 is shown. Firstly, as indicated in step 271, the user is requested to input an account number and a password. Then, as indicated in step 272, the processing unit 10 determines whether the user's account number and password pass verification. If the user's account number and password pass verification, then the method proceeds to step 273. If the user's account number and password do not pass verification, then the process is terminated. Next, as indicated in step 273, at least a facial image of the user is captured. For example, the facial image is taken from five different angles. Then, as indicated in step 274, the facial image is analyzed to generate the user's facial characteristic. Next, as indicated in step 275, the user's facial characteristic is stored into the database, and the user is accredited as an encrypting-permission user, so that the user's facial characteristic is provided for verification when the user would like to encrypt the digital data.

On the other hand, if the user clicks decrypting selection in step 230, then the method proceeds to step 242. In step 242, the user's facial characteristic is captured. Step 242 is similar to step 240 and also comprises a plurality of sub-steps as disclosed in FIG. 3 but not repeated here. Then, the method proceeds to step 252, the processing unit 10 determines whether the user's facial characteristic matches with a facial characteristic of a decrypting-permission user corresponding a digital data. If the user's facial characteristic does not match with the facial characteristic of the decrypting-permission user corresponding the digital data, then the process is terminated. If the user's facial characteristic matches with the facial characteristic of the decrypting-permission user corresponding the digital data, then the method proceeds to step 262, the user is allowed to decrypt the digital data. After an encrypting-permission user encrypts a digital data, the encrypting-permission user is the decrypting-permission user corresponding the digital data. Thus, in a decrypting process, the digital data is encrypted after the image recognition system analyzes the facial characteristic of a decrypting-permission user corresponding the digital data.

Step 260 and step 262 respectively encrypts and decrypts the digital data. In the encrypting process, the digital data, such as a file, a plurality of files, a file folder or a plurality of file folders, are compressed as a compression file. In the decrypting process, the compression file is decompressed as what it originally was such as a file, a plurality of files, a file folder or a plurality of file folders.

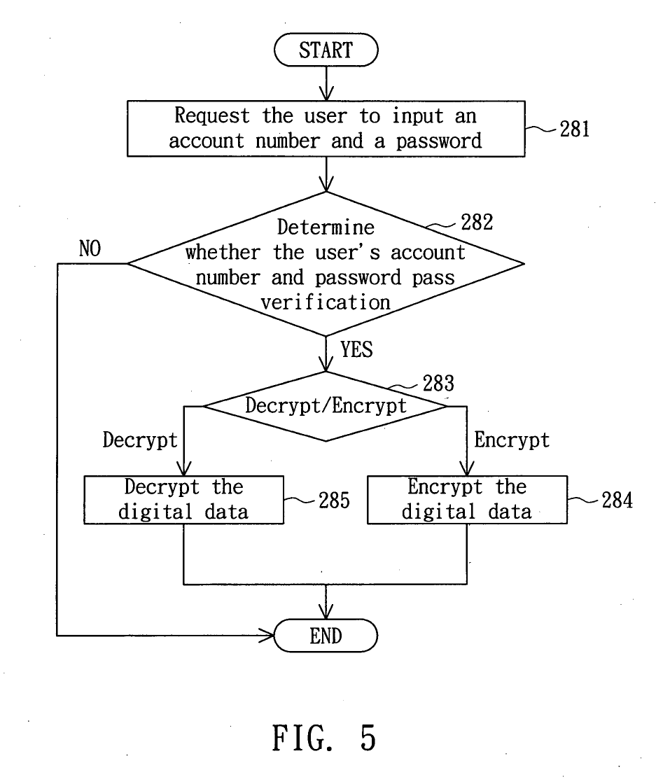

In step 220, if the processing unit 10 determines that the electronic device can not activate the image recognition system, then the method proceeds to step 280. In step 280, the digital data is encrypted or decrypted at a text input mode. Referring to FIG. 5, a detailed flowchart of step 280 of FIG. 2 is shown. Firstly, as indicated in step 281, the user is requested to input an account number and a password. Then, the method proceeds to step 282, the processing unit 10 determines whether the user's account number and password pass verification. If the user's account number and password pass verification, then the method proceeds to step 283. If the user's account number and password do not pass verification, then the process is terminated. In step 283, the processing unit 10 determines whether the encrypting selection or the decrypting selection is clicked. If the crypt ion selection is clicked, then the method proceeds to step 284, the user is allowed to encrypt the digital data. If the decrypting selection is clicked, then the method proceeds to step 285, the user is allowed to decrypt the digital data.

A computerized data management method and a computerized data management system using the same are disclosed in the above embodiment of the invention. As face recognition technology is used in computerized data management, the computerized data management method and the computerized data management system using the same have many advantages stated below.

Firstly, the digital data is encrypted and compressed as a compression file, such that other users are incapacitated of opening the compression file or viewing the contents of the file such as file name and recording time, hence protecting the data.

Secondly, the user, according to the facial characteristic analyzed by an image recognition system, determines whether he or she has the permission to encrypt or decrypt a digital data so as to automatically encrypt or decrypt the digital data without having to remember the complicated password.

Thirdly, in the present embodiment of the invention, the image capturing unit can be built-in the electronic device, further facilitating convenience of operation.

Fourthly, in the present embodiment of the invention, the user can choose to encrypt or decrypt the digital data by clicking the mouse right-key selection menu, making the protection of digital data simpler and more convenient.

Fifthly, in the present embodiment of the invention, the computerized data management system has both a text input mode and an image recognition system for determining whether a user is allowed to encrypt or decrypt a digital data, such that the user is able to encrypt or decrypt a digital data under different working environment. For example, when an electronic device can not activate the image recognition system or the user can not perform image recognition, the user still can decrypt or encrypt a digital data at a text input mode.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computerized data management method used for encrypting/decrypting a digital data of an electronic device, the computerized data management method comprising:
(a) capturing a user's facial characteristic;
(b) determining, in an encrypting process, whether the user's facial characteristic matches with an encrypting-permission user's facial characteristic stored in a database;
(c) allowing the user to encrypt the digital data in an encrypting process if the user's facial characteristic matches with the encrypting-permission user's facial characteristic stored in the database;
(d) determining, in a decrypting process, whether the user's facial characteristic matches with the a facial characteristic of a decrypting-permission user corresponding a digital data; and
(e) allowing the user to decrypt the digital data in a decrypting process if the user's facial characteristic matches with the facial characteristic of the decrypting-permission user corresponding the digital data.

2. The computerized data management method according to claim 1, wherein before the step (a), the computerized data management method further comprises:
(f) activating an image capturing unit.

3. The computerized data management method according to claim 2, wherein the step (a) further displays the user's a facial image on a display screen.

4. The computerized data management method according to claim 2, wherein the step (a) further comprises:
(a1) capturing the user's at least a facial image by the image capturing unit; and
(a2) analyzing the facial image by an image recognition system to generate the user's facial characteristic.

5. The computerized data management method according to claim 1, wherein after the step (c), the computerized data management method further comprises:
(g) encrypting and compressing the digital data.

6. The computerized data management method according to claim 5, wherein the digital data is a file, a plurality of files, a file folder or a plurality of file folders, and in the step (g), the file, the files, the file folder or the file folders are compressed as a compression file.

7. The computerized data management method according to claim 1, wherein after the step (d), the computerized data management method further comprises:
(h) decrypting and decompressing the digital data.

8. A computerized data management system used for encrypting/decrypting a digital data of an electronic device, the computerized data management system comprising:
an image capturing unit used for capturing a user's facial characteristic;
a database used for storing at least an encrypting-permission user's facial characteristic and at least a decrypting-permission user's facial characteristic;
an encrypting unit used for encrypting the digital data;
a decrypting unit used for decrypting the digital data; and
a processing unit wherein in an encrypting process, the processing unit is used for determining whether the user's facial characteristic matches with the encrypting-permission user's facial characteristic stored in the database, and if the user's facial characteristic matches with the encrypting-permission user's facial characteristic stored in the database, then the processing unit allows the user to encrypt the digital data, and in a decrypting process, the processing unit is used for determining whether the user's facial characteristic matches with the facial characteristic of the decrypting-permission user corresponding the digital data, and if the user's facial characteristic matches with the facial characteristic of the decrypting-permission user corresponding the digital data, then the user is allowed to decrypt the digital data.

9. The computerized data management system according to claim 8, the decrypting-permission user corresponding the digital data is the user encrypting the digital data.

10. The computerized data management system according to claim 8, wherein the encrypting unit is further used for compressing the digital data.

11. The computerized data management system according to claim 10, wherein the digital data is a file, a plurality of files, a file folder or a plurality of file folders, and the encrypting unit compresses the file, the files, the file folder or the file folders as a compression file.

12. The computerized-data management system according to claim 11, wherein the decrypting unit is further used for de-compressing the compression file.
